(19) United States
(12) Patent Application Publication
(10) Pub. No.: US 2014/0298941 A1
(43) Pub. Date: Oct. 9, 2014

(54) Kinematically Coupled Gear Assemblies and Methods of Manufacturing the Same

(71) Applicant: Ford Global Technologies LLC, Dearborn, MI (US)

(72) Inventor: Michael Tekletsion Berhan, Sylvania, OH (US)

(73) Assignee: Ford Global Technologies LLC, Dearborn, MI (US)

(21) Appl. No.: 13/858,225

(22) Filed: Apr. 8, 2013

(51) Int. Cl. F16H 55/12

(52) U.S. Cl. CPC F16H 55/12
USPC 74/445; 29/893.3

(57) ABSTRACT

A herringbone gear assembly, includes: a first gear segment having a first set of teeth; a second gear segment having a second set of teeth, wherein the second set of teeth have a different configuration than the first set of teeth; and a series of compatible locators on the first and second gear segments configured to assist with gear segment alignment.

### TECHNICAL FIELD

The present disclosure relates to kinematically coupled gear assemblies and methods of manufacturing the same, particularly, gear assemblies that have gear teeth of differing configurations.

### BACKGROUND

Modern mechanical designs incorporate the use of complex gearing when needed. Complex gears can have gear segments (or disks) coupled together. Each gear segment has gear teeth having differing configurations. Herringbone gears, for example, are gear assemblies having helical tooth patterns with opposing angles. Herringbone gears mesh (or mate) with other herringbone gears having complementary helical angles. Herringbone gear assemblies are beneficial since such gear assemblies allow for cancellation of gear-meshing thrust forces and their resultant overturning moments, thereby reducing system stresses, weight, part costs, and drag losses.

Manufacturing complex gears can, however, have its challenges. Machining and/or assembling gear assemblies with opposite helical angles, for example, is difficult to do while maintaining target positional tolerance in all six kinematic degrees of freedom (X, Y, Z, θ_{X}, θ_{Y}, and θ_{Z}, e.g., as shown in FIG. 1). High-volume manufacturing also can create issues of repeatability.

Furthermore, more axially-compact herringbone gears also present a unique challenge as when separate hobbing, milling, or similar tools are used to form teeth on opposing sides of the gear a certain amount of clearance between each opposing tool and side will be necessary. This is not ideal for forming gear teeth of different shapes or radius, and machining flexibility is limited. When separate milling tools are used to form teeth on opposing sides of the gear a certain amount of clearance between each tool is necessary. Therefore, relatively complex (i.e., more costly) shapers and shaving tools and machines are generally required to form gear teeth of different angles on the same gear assembly.

In the alternative, gears having teeth with opposing angles can be shaped in segments and later assembled. Attaching one gear segment to another post-forming adds positional and alignment tolerance concerns between segments. The same tolerance issues extend to intermeshing herringbone assemblies manufactured in segments.

Some existing kinematic coupling techniques seek to resolve alignment tolerance issues by providing reference contacts on each segment of the couplings particular mechanical system. The contacts are used as points of reference in manufacturing. U.S. Pat. No. 6,193,430 titled “Quasi-Kinematic Coupling and Method for Use in Assembling and Locating Mechanical Components and the Like” discloses the use of matable contacts between components with conical protrusions and grooves having relieved sides that enable high stiffness in a direction orthogonal to each contact line but low stiffness in a direction transverse to contact lines. Undesired rotation can result pre-attachment from having conical/spherical complementary contacts. Also, the use of a separate fastener through each contact can cause extra cost and manufacturing investment.

Therefore, it is desirable to have improved manufacturing techniques for kinematically coupled gear assemblies, particularly, gear assemblies that have gear teeth with differing configurations, such as, e.g., herringbone gear assemblies.

### SUMMARY

The present disclosure addresses one or more of the above-mentioned issues. Other features and/or advantages will become apparent from the description which follows.

One advantage of the present disclosure is that it discloses manufacturing techniques for kinematically coupled gear assemblies, particularly, gear assemblies that have gear teeth with differing configurations, such as, e.g., herringbone gear assemblies. Higher precision and repeatability of gear mesh position and alignment in all six degrees of freedom is provided. Less expensive tooling can be used even for gear designs having tighter axial packaging or relatively higher power density.

One exemplary embodiment of the present disclosure relates to a herringbone gear assembly, having: a first gear segment having a first set of teeth; a second gear segment having a second set of teeth, wherein the second set of teeth have a different configuration than the first set of teeth; and a series of compatible locators on the first and second gear segments configured to assist with gear segment alignment.

Another exemplary embodiment of the present disclosure relates to a herringbone gear assembly, having: a first gear segment having a first set of teeth; a second gear segment having a second set of teeth, wherein the second set of teeth have a different configuration than the first set of teeth; three equally spaced receptors formed on the first gear segment; and three equally spaced keys formed on the second gear segment. The keys are configured to at least partially fit in receptors when the first and second gear segments are attached in a predetermined configuration.

Another exemplary embodiment of the present disclosure relates to a method of manufacturing a gear assembly having variable teeth, the method including: forming a first set of teeth on a perimeter of a first gear segment; and forming locating grooves on a side of the first gear segment, the locating grooves configured to align the first gear segment with respect to a second gear segment.

The invention will be explained in greater detail below by way of example with reference to the figures, in which the same reference numbers are used in the figures for identical or essentially identical elements. The above features and advantages and other features and advantages of the present teachings are readily apparent from the following detailed description of the best modes for carrying out the invention when taken in connection with the accompanying drawings. In the figures:

### BRIEF DESCRIPTION OF THE DRAWINGS

FIG. 1 is a perspective cut-away view of a herringbone gear assembly according to an exemplary embodiment of the present disclosure.

FIG. 2 is an assembly view of multiple segments of the herringbone gear assembly of FIG. 1.

FIG. 3 is a perspective view of the herringbone gear assembly of FIG. 2 at circle 3.

FIG. 4 is a perspective view of a portion of the herringbone gear assembly of FIGS. 1-3 with a manufacturing tool for the herringbone gear assembly.

FIG. 5 is an assembly view of multiple segments of another exemplary herringbone gear assembly.

FIG. 6 is a perspective view of the herringbone gear assembly of FIG. 5 at circle 6.

FIG. 7 is an assembly view of multiple segments of another exemplary herringbone gear assembly.

FIG. 8 is a cross-sectional side view of the herringbone gear assembly of FIG. 7 at circle 8.

### DETAILED DESCRIPTION

Referring to the drawings, wherein like characters represent examples of the same or corresponding parts throughout the several views, there is shown exemplary, herringbone gear assemblies for use in an automotive gear train. Gear assemblies have teeth with opposing angles on each side of the assembly. The illustrated gear assemblies are manufactured according to the present disclosure. Two separate segments of the gear assemblies are independently toothed and subsequently fixed together. A series of complementary (or mating) locators are positioned on adjacent surfaces of each gear segment. The locators improve manufacturing techniques for the gear assemblies enabling movement post contact but pre-attachment, while still providing a rigid connection post attachment. Thereby, greater tolerances during assembly are obtained while meeting any preexisting limited design tolerances post assembly.

Various key and receptor concepts are illustrated in the drawings attached herewith. Exemplary locators can be used with any sort of gear segments or kinematic couplings.

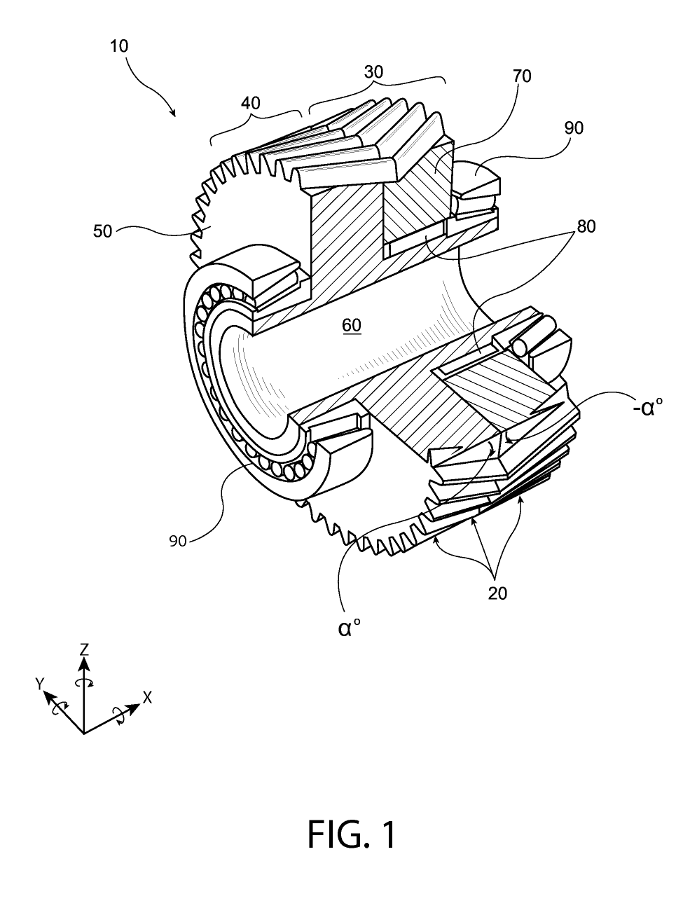

FIG. 1 is a perspective cut-away view of a herringbone gear assembly 10 according to an exemplary embodiment of the present disclosure. Gear assembly 10 is designed for use in an automotive transmission. As illustrated, gear assembly 10 includes teeth 20 on an external circumference of the gear assembly. Teeth 20 include two sections 30, 40 of teeth pitched or angled in opposing directions. On one side of the gear assembly 10 a series of teeth are pitched by an angle of alpha, α, with respect to the x-axis, as shown. Another series of teeth on an adjacent side of the gear assembly are pitched at an angle of negative alpha, -α, with respect to the x-axis. Teeth positioned at opposing angles form a herringbone pattern on the exterior circumference of the gear assembly.

In the particular herringbone gear assembly 10 shown in FIG. 1, the assembly is manufactured in segments and later attached. Gear segment 50 includes a set of teeth 40 on its outer circumference. A shaft 60 is also attached to gear segment 50. Gear segment 70 includes set of teeth 30 and is journaled onto shaft 60 of gear segment 50. No separate fasteners are required. In this arrangement a set of tapered roller bearings 90 are included in the gear assembly 10 to enable gear teeth (e.g., 20) to rotate with respect to another component (not shown). Bearings 90 are journaled onto shaft 60 and sandwich gear segments 50, 70. Positioning and forming of each set of teeth 30, 40 with respect to each other can be difficult, as previously discussed.

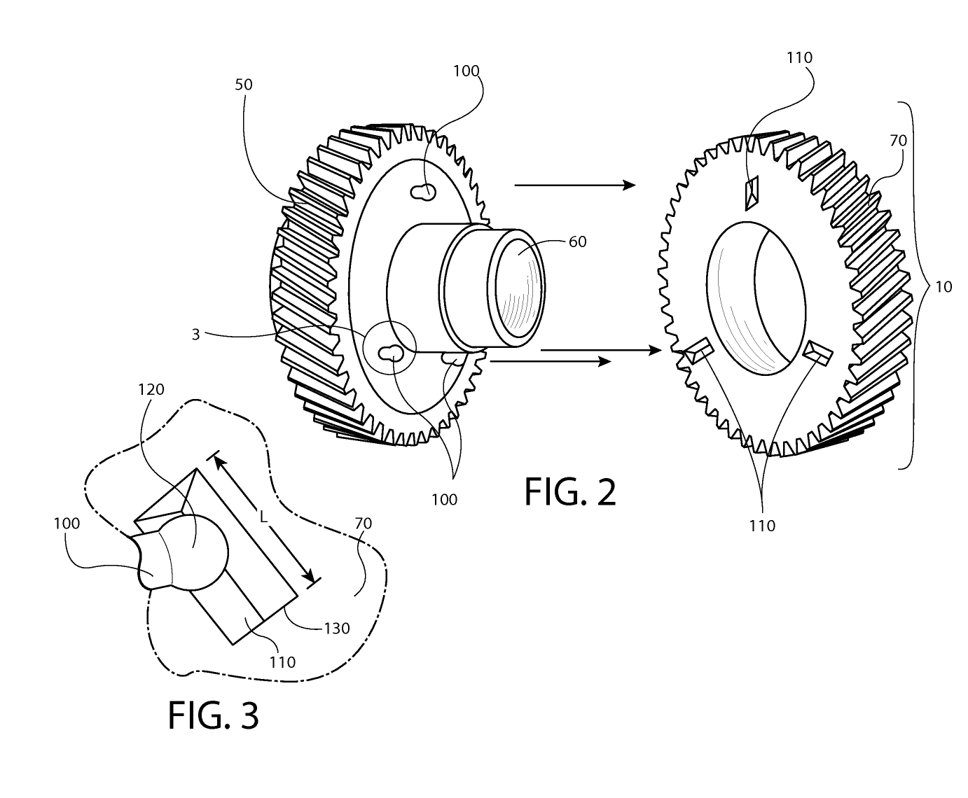

FIGS. 2-4 show an assembly and manufacturing process for the herringbone gear assembly 10 of FIG. 1. FIG. 2 is an assembly or exploded view of gear segments 50, 70 of the herringbone gear assembly 10 of FIG. 1. As shown, gear segments 50, 70 include a series of compatible locators 100, 110. Locators 100, 110 are configured to assist with gear segment alignment. Gear segments 50, 70 are shown in a pre-contact and pre-attachment condition, as opposed to FIG. 1, which shows gear segments in a post-attachment condition. Gear segment 50 includes keys 100 formed on an inner surface of gear. Three keys 100 are shown in this embodiment. Each key 100 is positioned on the inner surface of gear segment 50 to form an equilateral triangle. Keys 100 are also thus positioned at the same distance apart with respect to each other. In this embodiment, keys 100 have a spherical profile 120, as shown in FIG. 3.

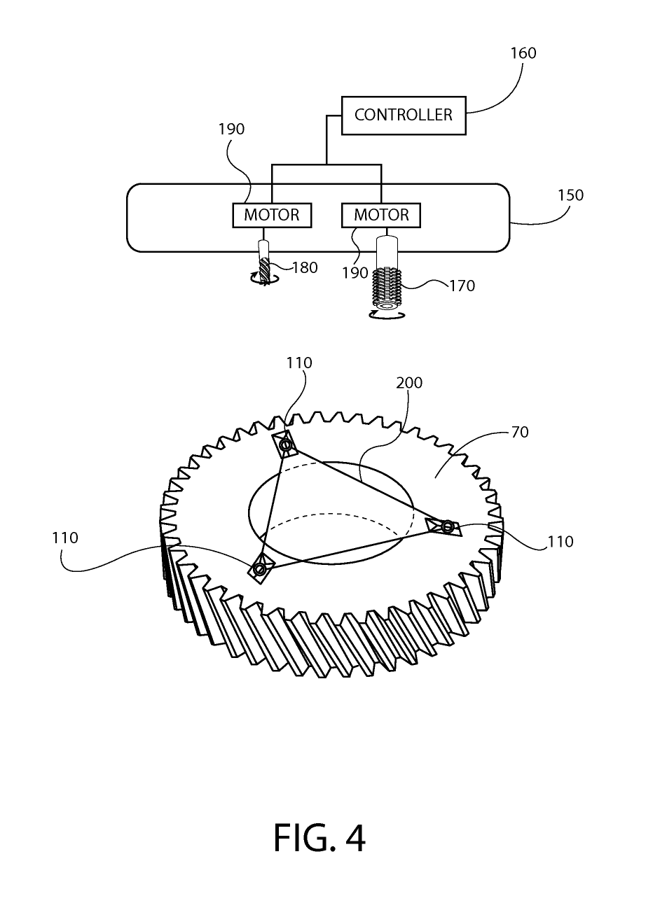

Gear segment 70, as shown in FIG. 2, includes three receptors 110 formed on an inner surface of gear segment. Each receptor 110 is positioned to form an equilateral triangle—as shown in FIG. 4 as well.

As illustrated in FIG. 3, when in contact, key 100 partially fits in receptor 110. FIG. 3 is a perspective view of the herringbone gear assembly of FIG. 2 at circle 3. Receptor 110 has a rectangular opening 130 such that a length of receptor is greater than a width of receptor. Receptor 110 tapers in along a depth of receptor or gear segment 70.

A length of receptor 110, as shown in FIG. 3, is sized greater than the diameter of the spherical profile 120 on key 100. In this manner, even when the spherical profile 120 of key 100 is partially fitted in receptor 110, key is allotted some translation or linear movement in receptor, i.e., along line, L, as shown. Accordingly, receptors 110 are not required to be sized exactly to the dimension of keys 100. Greater flexibility during assembly is obtained. Still, keys are restricted from movement when all three keys 100 are fitted in one of the three receptors 110 and the gear segments 50, 70 are attached. Receptors 110, as illustrated, are configured to enable keys 100 to move in a linear direction of freedom, e.g., L, pre-attachment of gear segments 50 and 70 and restrict keys 100 from moving with respect to the direction of freedom post-attachment of gear segments. In this embodiment, receptors 110 are triangular in shape.

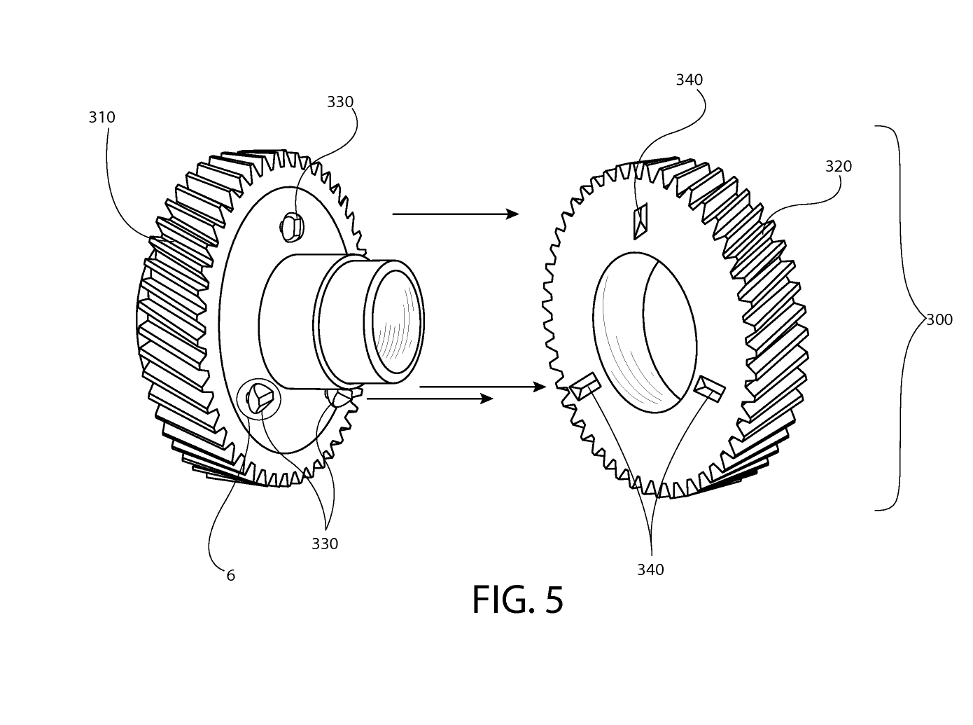

The spherical profile 120 and v-groove or receptor 110 compatible locators allow for high precision of position and alignment in all six degrees of freedom (or DOFs), process repeatability, and solid load-carrying capability. Keys 100 and receptors 110 offer μm-level positioning, limited only by machining tolerances, and sub-μm repeatability. The ball and v-groove design also provides for a configuration conducive to high temperatures since the centerlines for aligning each element expand/contrast and the same rate. In other embodiments, keys and receptors can be formed in other shapes as discussed, for example with respect to FIGS. 5-8.

Now turning to FIG. 4, there is shown therein a perspective view of a portion of the herringbone gear assembly of FIGS. 1-3 together with a manufacturing device 150 for the herringbone gear assembly. The arrangement of FIG. 4 is suitable for executing a method of manufacturing a herringbone gear assembly. Shown in FIG. 4, the manufacturing device 150 is a computer numeric control (or “CNC”) machine. Gear segment 70 of FIG. 2 is also shown. CNC machine includes a controller 160 with cutting algorithm for forming teeth and receptors on gear segment 70. Tool 170 is a hob for teeth forming; tool 180 is a bit for receptor forming. In this embodiment, each tool is run by a separate motor 190.

For the illustrated gear assembly of FIGS. 1-4 the method of manufacturing includes: forming a first set of teeth on a perimeter of a first gear segment. For example, teeth on segment 70 are formed using tool 170. The method also includes forming locating grooves (e.g., receptors 110) on a side of the first gear segment; the locating grooves are configured to align the first gear segment with respect to a second gear segment (e.g., 50 as shown in FIG. 2). The order of these steps can be reversed. In one embodiment grooves govern positioning of the gear assembly and any meshing gears; grooves are manufactured before gear teeth. Receptors 110 serve as datum for the mesh. Tool 180 of FIG. 4 can be used to execute the forming step for receptors 110. In this embodiment, forming locating grooves includes forming triangular shaped grooves. Grooves are also positioned equal distances apart with respect to each other, e.g., as shown in FIG. 4. A kinematic datum mount 200, such as shown, can be used to precisely manufacture and align the two gear segments. In another embodiment a gear center bore can be used.

CNC machine 150 of FIG. 4 can be used to form a second set of teeth, having a different configuration than the first set of teeth, on a perimeter of the second gear segment 50 and incorporating compatible keys on the gear segment (e.g., 100 as shown in FIG. 2). The compatible keys 100 are configured to at least partially fit in receptors 110, as shown in FIG. 3.

In a post-milling process the two gear segments 50, 70 are attached together using complementary locators (e.g., 100 and 110).

CNC machine 150 of FIG. 4 can be used to form compatible keys 100 on gear segment 50, e.g., 100 as shown in FIG. 2. Forming the compatible keys can include forming the spherical profile 120 on the keys. Other shapes or configurations for the locating grooves and compatible keys can be formed, e.g., as discussed hereinbelow with respect to FIGS. 5-8.

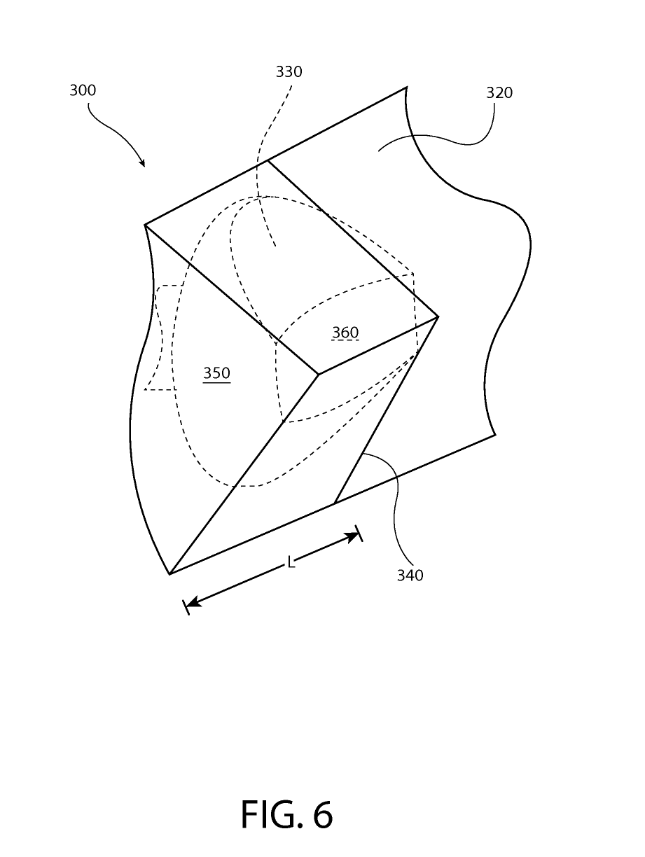

FIG. 5 is an assembly view of multiple segments of another exemplary herringbone gear assembly 300. As shown, gear assembly 300 includes two gear segments 310, 320 having a series of compatible locators 330, 340. Locators 330, 340 are configured to assist with gear segment alignment. Gear segments 310, 320 are shown in a pre-contact and pre-attachment condition. Gear segment 310 includes keys 330 formed on an inner surface of gear. Three keys 330 are shown in this embodiment. Each key 330 is positioned on the inner surface of gear segment 310 to form an equilateral triangle. Keys 330 are also thus positioned at the same distance with respect to each other. In this embodiment, keys 330 have a triangular profile 350 as shown in FIG. 6. The methods of manufacturing previously described can also include the step of forming a triangular profile on the key, e.g., 350. Triangular profile 350 can be formed with gear segment 310 or formed separately and later attached, for example, via press-fitting or with a threaded connector at one end of key 330.

Gear segment 320, as shown in FIG. 5, includes three receptors 340 formed on an inner surface of gear segment. Each receptor 340 is positioned to form an equilateral triangle.

As illustrated in FIG. 6, when in contact, key 330 fully fits in receptor 340. FIG. 6 is a perspective view of the herringbone gear assembly 300 of FIG. 5 at circle 6. Receptor 340 has a rectangular opening such that a length of receptor is greater than a width of receptor. Receptor 340 tapers in along a depth of receptor or gear segment 320. Receptor 340, as illustrated, is configured so that key 330 is restricted from moving in a linear direction of freedom, e.g., L, pre-attachment of gear segments 310 and 320. Key 330 includes a truncated profile. Triangular profile 350 ends at 360. The truncated profile adds clearance between key 330 and receptor 340 walls when key is inserted in the receptor.

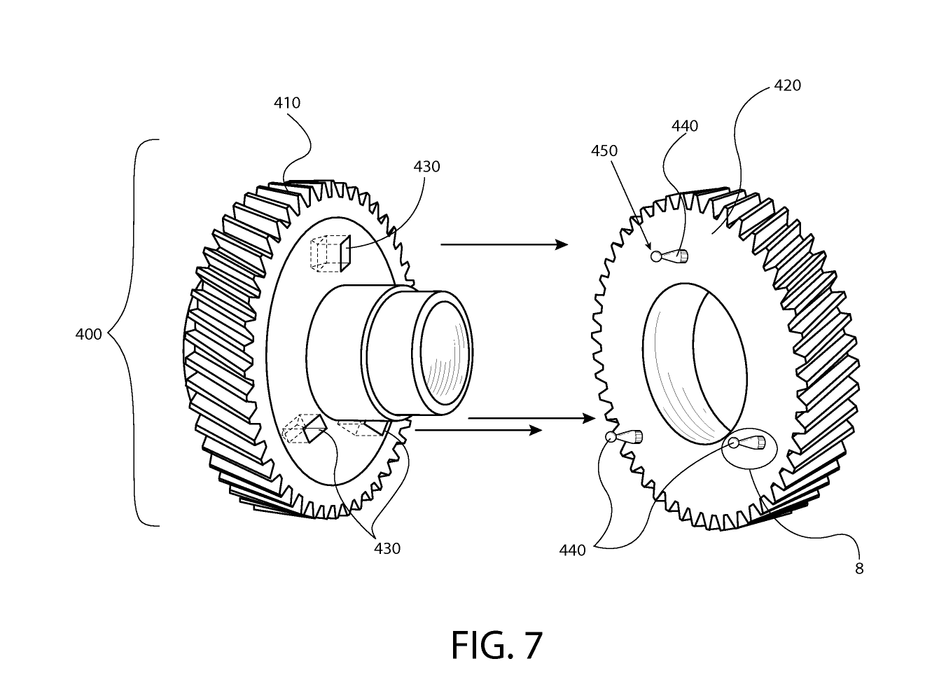

Now turning to FIG. 7, there is shown therein an assembly view of multiple segments of another exemplary herringbone gear assembly 400. As shown, gear assembly 400 includes two gear segments 410, 420 having a series of compatible locators 430, 440. Locators 430, 440 are configured to assist with gear segment alignment. Gear segments 410, 420 are shown in a pre-contact and pre-attachment condition. Gear segment 420 includes keys 440 formed on an inner surface of gear. Three keys 440 are shown in this embodiment. Each key 440 is positioned on the inner surface of gear segment to form an equilateral triangle. Keys 440 are also thus positioned at the same distance with respect to each other. In this embodiment, keys 440 have a spherical profile 450. Keys 440 include a tapered shaft 460 as well. Spherical profile 450 can be formed with gear segment 420 or formed separately and later attached, for example, via press-fitting or with a threaded connector at one end.

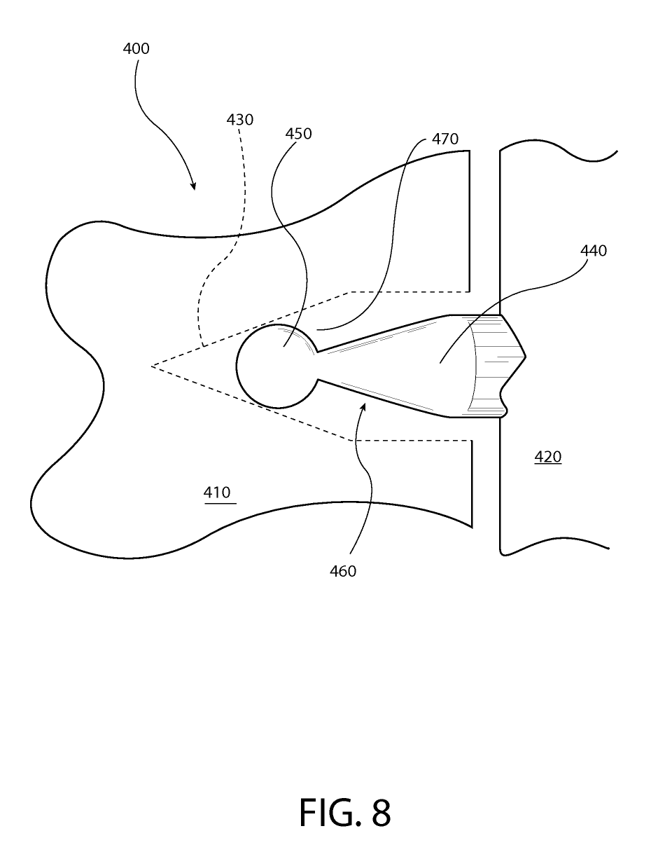

Gear segment 410, as shown in FIG. 7, includes three receptors 430 formed on an inner surface of gear segment. Each receptor 430 is positioned to form an equilateral triangle. In this embodiment, receptors 430 are rectangular in shape, having a triangular end as shown in FIG. 8. Receptors 430 can be formed using some of the method of manufacturing discussed hereinabove. The method can also include forming cylindrical shaped grooves.

As illustrated in FIG. 8, when in contact, key 440 fits in receptor 430. FIG. 8 is a cross-sectional side view of the herringbone gear assembly 400 of FIG. 7 at circle 8. Receptor 430 has a square opening 470. Receptor 430 has a depth configured to at least partially fit spherical profile 450 and shaft 460 of key 440 therein. Receptors 430, as illustrated, are configured so that keys 440 are partially restricted from moving pre-attachment of gear segments 410, 420. Keys 440 can rotate with respect to receptor 430, pre attachment.

The size of keys and receptors can vary depending of the circumstances of use or performance demands. In one embodiment, Hertzian static contact sizes the balls and the torque carrying centerline distances. Where contact stresses are higher, quasi-kinematic (greater elastic load sharing, or “elastic averaging”) couplings can be used, such as cylinders (line contact) vs. balls (point contact), which is directly analogous to roller bearings vs. ball bearings.

In the illustrated embodiments, gear segments and keys are composed of a steel alloy. Other materials can be used however, for example, including cast iron alloys, aluminum alloys, composites, polymers, or magnesium alloys.

Those familiar with the art to which this invention relates will recognize various alternative designs and embodiments for practicing the invention within the scope of the appended claims.

We claim:

1. A herringbone gear assembly, comprising:
a first gear segment having a first set of teeth;
a second gear segment having a second set of teeth, wherein the second set of teeth have a different configuration than the first set of teeth; and
a series of compatible locators on the first and second gear segments configured to assist with gear segment alignment.

2. The gear assembly of claim 1, wherein the compatible locators include:
receptors formed on the first gear segment; and
keys formed on the second gear segment;
wherein the keys are at least partially fittable in the receptor.

3. The gear assembly of claim 2, wherein the receptors are locating grooves.

4. The gear assembly of claim 3, wherein the keys include a spherical profile.

5. The gear assembly of claim 4, wherein the keys include a triangular profile.

6. The gear assembly of claim 3, wherein the keys include a triangular profile.

7. The gear assembly of claim 6, wherein the compatible locators are equidistantly spaced apart.

8. The gear assembly of claim 2, wherein the keys include a spherical profile.

9. The gear assembly of claim 2, wherein the keys include a triangular profile.

10. The gear assembly of claim 1, wherein the compatible locators are equidistantly spaced apart.

11. A herringbone gear assembly, comprising:
a first gear segment having a first set of teeth;
a second gear segment having a second set of teeth, wherein the second set of teeth have a different configuration than the first set of teeth;
three equally spaced receptors formed on the first gear segment; and
three equally spaced keys formed on the second gear segment;
wherein the keys are configured to at least partially fit in receptors when the first and second gear segment are attached in a predetermined configuration.

12. A method of manufacturing a gear assembly having variable teeth, comprising:
forming a first set of teeth on a perimeter of a first gear segment; and
forming locating grooves on a side of the first gear segment, the locating grooves configured to align the first gear segment with respect to a second gear segment.

13. The method of claim 12, further comprising:
forming a second set of teeth having a different configuration than the first set of teeth on a perimeter of the second gear segment;
incorporating compatible keys on the second gear segment, the compatible keys at least partially fittable in grooves; and
attaching the first and second gear segment together.

14. The method of claim 13, wherein forming locating grooves includes forming triangular shaped grooves.

15. The method of claim 14, further comprising:
forming the compatible keys;
wherein the forming the compatible keys includes forming a spherical profile on the keys.

16. The method of claim 13, further comprising:
forming the compatible keys.

17. The method of claim 16, wherein forming the compatible keys includes forming a triangular profile on the keys.

18. The method of claim 16, wherein forming the compatible keys includes forming a spherical profile on the keys.

19. The method of claim 12, further comprising:
forming the compatible keys;
wherein forming the compatible keys includes forming a spherical profile on the keys.

20. The method of claim 19, further comprising:
positioning the locating grooves equal distances apart with respect to each other.
